(19) United States
(12) Patent Application Publication
(10) Pub. No.: US 2026/0166763 A1
(43) Pub. Date: Jun. 18, 2026

(54) LOCKING MECHANISM FOR KNIFE WITH REPLACEABLE BLADE

(71) Applicant: Outdoor Edge Cutlery, LLC, Maple Grove, MN (US)

(72) Inventor: Mike Feesl, Inver Grove Heights, MN (US)

(73) Assignee: Outdoor Edge Cutlery, LLC, Maple Grove, MN (US)

(21) Appl. No.: 19/425,276

(22) Filed: Dec. 18, 2025

Related U.S. Application Data
(63) Continuation-in-part of application No. 19/419,688, filed on Dec. 15, 2025.
(60) Provisional application No. 63/735,435, filed on Dec. 18, 2024.

(51) Int. Cl. B26B 5/00; B26B 1/04

(52) U.S. Cl. CPC B26B 5/00; B26B 1/04

(57) ABSTRACT

An improved locking mechanism for knives that utilize a replaceable blade. The improved locking mechanism works in conjunction with a first locking mechanism to more securely retain a replaceable blade within a knife that is structured and configured to retain replaceable blades. The improved locking mechanism can abut the first locking mechanism in a first position, thereby preventing movement of the first locking mechanism, or the improved locking mechanism can move away from the first locking mechanism to a non-abutting position, thereby allowing movement of the first locking mechanism.

### FIELD OF THE INVENTION

Embodiments of the present invention generally relate to knives. More specifically, one embodiment of the present invention is an improved locking mechanism for a folding knife that has a replaceable blade element. Another embodiment is an improved locking mechanism for a non-folding knife with a replaceable blade element.

### BACKGROUND

Knives are usually comprised of a handle with a blade that is interconnected thereto. Some knives employ blades that are rotatably interconnected, and selectively lockable, to the handle. When the knife is not in use, it is sheathed or, in the case of folding knives, the blade is folded into the handle. When in use, the rotatable blade is extended from the handle and locked in place. Such locking mechanisms are known and engage a portion of the blade to hold it in place until the user disengages the lock mechanism, which allows the blade to be folded into an opening in the handle to conceal all or a portion of the blade.

Regardless of knife type, it is desirable to provide a cutting edge that is very sharp, similar to the sharpness provided by a razor blade. Replaceable blades by their nature must be securable or lockable within the knife for proper usage. An unsecured blade would be of little value and potentially dangerous to a user. However, some uses of secured replaceable blades can generate significant force on the blade in the plane parallel to the cutting edge of the blade. For example, a saw blade, installed/secured within a knife's blade carriers, may generate substantial friction when employed in cutting a dense material. Such force upon the installed/secured blade may overwhelm the current locking mechanism that holds the blade within the blade carriers and cause the accidental release of the blade from the knife.

The following disclosure describes an improved locking mechanism for a knife with a replaceable blade that can further secure the replaceable blade within the blade carriers of the knife. Such an improved locking mechanism may facilitate easy interconnection.

### SUMMARY

The Summary of the Invention is neither intended nor should it be construed as being representative of the full extent and scope of the present invention. Moreover, references made herein to “the present invention” or aspects thereof should be understood to mean certain embodiments of the present invention and should not necessarily be construed as limiting all embodiments to a particular description. The present invention is set forth in various levels of detail in the Summary of the Invention as well as in the attached drawings and the Detailed Description of the Invention, and no limitation as to the scope of the present invention is intended by either the inclusion or non-inclusion of elements, components, etc. in this Summary of the Invention. Additional aspects of the present invention will become more readily apparent from the Detail Description, particularly when taken together with the drawings.

In a first illustrative but non-limiting example, the disclosure provides a knife having a blade receptacle, a first locking mechanism disposed within the blade receptacle, a release mechanism configured to disengage the first engaging element from the second engaging element, and a second locking mechanism. The blade receptacle can have a longitudinal axis that is structured and configured to receive a replaceable blade. The first locking mechanism can include a biasing element having a first engaging element near a distal end of the biasing element, and the first engaging element can be structured and configured to engage with a corresponding second engaging element on the replaceable blade to retain the replaceable blade within the blade receptacle. The second locking mechanism can be positionable between a first position and a second position. The first position can abut the biasing element to prevent movement of the biasing element, and the second position can be apart from the biasing element and configured to allow movement of the biasing element.

In some cases, the biasing element can be a living hinge. Further, the second locking mechanism can be disposed within a plane parallel to the living hinge. In some cases, the second locking mechanism can operate in a plane parallel to the longitudinal axis of the blade receptacle. In some cases, the first engaging element can be one of a protrusion or an opening. Further, the second engaging element can be the other of the protrusion or the opening. For example, the first engaging element may be a protrusion, the second engaging element may be an opening, and the second locking mechanism may be a slidable tab that covers the distal end of the biasing element when in the first position.

In some cases, the second locking mechanism can also include a cover, a slide lever, a position holder, and at least two position notches. Additionally, the position holder and at least two position notches may be disposed within a plane parallel to the living hinge, the position holder can be a component of one of the slide lever or the cover, the at least two position notches can be components of the other of the slide lever or the cover, the at least two position notches can comprise a distal position notch and a proximal position notch, the first position of the second locking mechanism can position the position holder within the distal position notch, and the second position of the second locking mechanism can position the position holder within the proximal position notch. In some cases, the cover may be positioned away from the handle, the at least two position notches may be components of a back portion of the cover, and the position holder can be a component of the slide lever. Alternatively, the cover may be positioned over the handle, the position holder can be a component of a back half of the handle cover, and the at least two position notches can be components of the slide lever.

In some cases, the release mechanism may be a release button. In some cases, the second locking mechanism may be slidable between the first position and the second position. In some cases, the knife can be combined with the replaceable blade. The first position may sandwich the biasing element between the second locking mechanism and the replaceable blade. In some cases, the blade receptacle may be comprised of two blade carriers, the biasing element may be an extension of one of the two blade carriers, the second locking mechanism may be positioned on a first side of the biasing element, and the other of the two blade carriers may be positioned on a second side of the biasing element.

In another illustrative but non-limiting example, the disclosure provides a method of locking a blade in a knife, the method comprising: sliding a blade into a blade carrier of a knife until an opening on an end of the blade engages with a protrusion on a first locking mechanism, wherein the first locking mechanism comprises the protrusion on an end of a biasing element; and pushing a slide lever along a longitudinal axis until at least a portion of the slide lever covers the protrusion of the first locking mechanism.

### BRIEF DESCRIPTION OF THE DRAWINGS

The following description should be read with reference to the drawings. The drawings, which are not necessarily to scale, depict examples and are not intended to limit the scope of the disclosure. The disclosure may be more completely understood in consideration of the following description with respect to various examples in connection with the accompanying drawings, in which:

FIG. 1 is a rear elevation view of an embodiment of a replaceable blade knife having an improved lock;

FIG. 2 is an example of a replaceable blade thereof;

FIG. 3 is an exploded view thereof;

FIG. 4 is a partially exploded view thereof;

FIG. 5 is a partially exploded view thereof;

FIG. 6 is a partially exploded view of the knife in a locked position thereof;

FIG. 7 is a partial bottom view thereof;

FIG. 8 is a front perspective view of another embodiment of a replaceable blade knife having an improved lock;

FIG. 9 is a rear elevation view thereof;

FIG. 10 is a partially exploded view thereof;

FIG. 11 is a partially exploded view thereof;

FIG. 12 is a partially exploded view of the knife in an unlocked position thereof;

FIG. 13 is a partial view thereof;

FIG. 14 is a partial view thereof;

FIG. 15 is a partial view thereof;

FIG. 16 is a partially exploded view of another embodiment of a replaceable blade knife having an improved lock;

FIG. 17 is a partial view thereof;

FIG. 18 is a partial view thereof;

FIG. 19 is a partial view thereof.

The above summary is not intended to describe each and every example or every implementation of the disclosure. The description that follows more particularly exemplifies various illustrative embodiments.

### DETAILED DESCRIPTION

The present disclosure relates to locking mechanisms for replaceable blade knives, and, more particularly, relates to improved locking mechanisms for both fixed and folding replaceable blade knives. Various embodiments are described in detail with reference to the drawings, in which like reference numerals may be used to represent like parts and assemblies throughout the several views. Reference to various embodiments does not limit the scope of the systems and methods disclosed herein. Examples of construction, dimensions, and materials may be illustrated for the various elements; those skilled in the art will recognize that many of the examples provided have suitable alternatives that may be utilized. Any examples set forth in this specification are not intended to be limiting and merely set forth some of the many possible embodiments for the systems and methods. It is understood that various omissions and substitutions of equivalents are contemplated as circumstances may suggest or render expedient, but these are intended to cover applications or embodiments without departing from the spirit or scope of the disclosure. Also, it is to be understood that the phraseology and terminology used herein are for the purpose of description and should not be regarded as limiting.

### SUMMARY OF REFERENCE TAGS

100-Knife embodiment
102-Blade Receptacle
104A-First Blade Carrier
104B-Second Blade Carrier
106-Spacer
110-First Locking Mechanism
112-Living Hinge
114-Protrusion
120-Second Locking Mechanism
122-Slide Lever
124-Position Holder
134-First Position Notch
136-Second Position Notch
140A-Front Cover
140B-Back Cover
150-Blade Release
180-Blade
190-Opening
200-Knife embodiment
202-Blade Receptacle
204A-First Blade Carrier
204B-Second Blade Carrier
206-Spacer
210-First Locking Mechanism
212-Living Hinge
214-Protrusion
220-Second Locking Mechanism
222-Slide Lever
224-Position Holder
228-Footing
234-First Position holder
236-Second Position holder
240A-Front Cover
240B-Back Cover
250-Blade Release
260-Liner
262-Liner Opening
265-Pivot Point
300-Knife embodiment
302-Blade Receptacle
304A-First Blade Carrier
304B-Second Blade Carrier
306-Spacer
308-Liner
310-First Locking Mechanism
312-Living Hinge
314-Protrusion
320-Second Locking Mechanism
322-Slide Lever
324-Position Holder
328-Footing
334-First Position holder
336-Second Position holder
340B-Back Cover
360-Liner
362-Liner Opening
365-Pivot Point

The described locking mechanism can be considered an improvement to the replaceable blade knives first described in the Chinese patent CN103786170B and its progeny US patent U.S. Pat. No. 9,687,987B2. Also, the described locking mechanism can be considered an improvement to the replaceable blade knives first described in U.S. Pat. No. 10,493,641B2 and its progeny. All of the above are incorporated herein by reference.

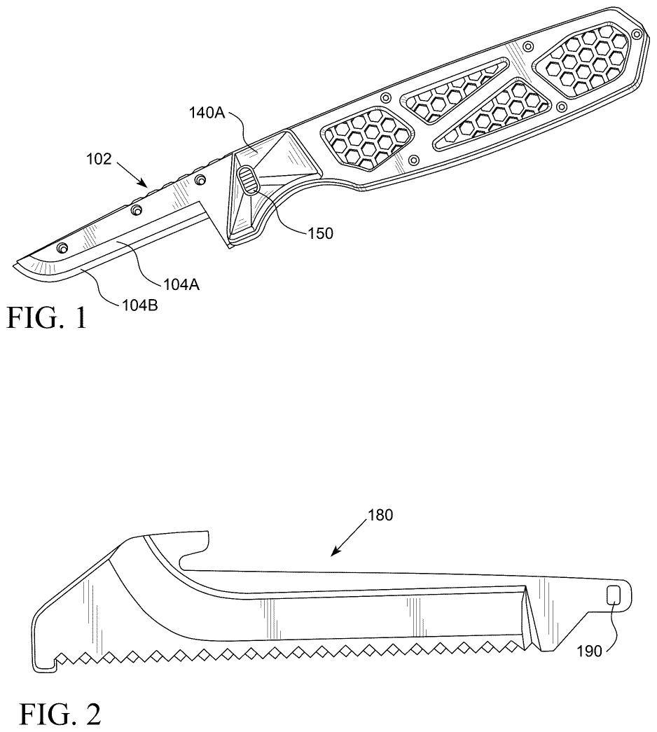

FIGS. 1-7 disclose a first embodiment of an improved locking mechanism for a knife having a replaceable blade. FIG. 2 illustrates a knife 100 having a blade receptacle 102, which can be comprised of a first blade carrier 104A and a second blade carrier 104B; the two blade carriers may be spaced apart via a spacer, or the two blade carries may be constructed in such a way that does not require a spacer. For example, the first blade carrier 104A may include a thicker construction at its proximal end to act as the spacer, or vice-versa. The spacer 106, as illustrated n FIG. 4, or other such spacing methods, can provide an opening in the blade receptacle 102 for the insertion of a replaceable blade, for example, the blade that is shown in FIG. 2. As illustrated, knife 100 is a fixed knife, and the blade carriers can be combined with the tang of the knife since there is no need for rotation.

In other versions of knife 100, the blade receptacle 102 may be constructed as a single piece that provides the same opening as with the version constructed with two blade carriers. As with earlier versions of a replaceable blade knife, as described in CN103786170B and its progeny, the blade carriers may include an offset in their profiles to ease insertion of a replaceable blade. As with the older versions, the knife 100 may include a blade release button 150. Such a button may include a coiled spring that maintains the button's position until it is depressed. Once depressed, the blade release button 150 can engage with a living hinge 112, which is part of a first locking mechanism 110. The first locking mechanism 110 can be formed into the proximal end of the blade receptacle 102 (the term proximal, as used herein, refers to the end of the knife that is closest to the user when the handle of the knife is being held). Included in the first locking mechanism 110 can be a protrusion 114, which can be structured and configured to engage with an opening on the proximal end of a replaceable blade, for example, opening 190 on the blade 180 as shown in FIG. 2. By inserting a blade 180 into the blade receptacle 102, the protrusion 114 on the living hinge 112 may be displaced until the protrusion 114 fully engages with the opening 190, thereby securing the blade 180 in the blade receptacle 102.

In earlier versions of such replaceable blade knives, the first locking mechanism comprised the locking mechanism used to secure a replaceable blade within the knife. However, due to the nature of the living hinge, some larger external forces can be capable of disengaging the protrusion from the blade opening and allowing the blade to release from the knife without depressing the release button. To ensure that such extreme forces do not overwhelm the first locking mechanism 110, a second locking mechanism 120 can be included in the replaceable blade knife 100.

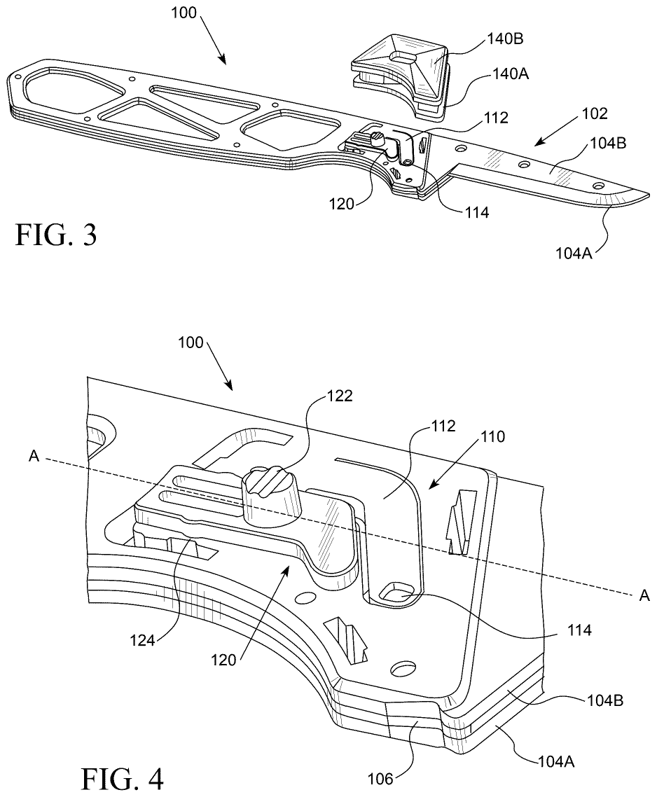

As illustrated in FIGS. 3-7, a second locking mechanism 120 can be disposed over the first locking mechanism 110. The second locking mechanism 120 can be housed within a cover 140A/B of the knife 100. Referring to FIGS. 4 and 6, the second locking mechanism 120 can be structured and configured to move along axis A. In FIG. 4, the second locking mechanism 120 is illustrated in an unlocked position. In the unlocked position, the second locking mechanism 120 can be positioned to the proximal end of the knife 100. In such an arrangement, the second locking mechanism 120 may be adjacent to, but not covering, the living hinge 112 of the first locking mechanism 110. In such an arrangement, the living hinge 112 can be flexed via the release button 150 and, at undesirable times, by a large external force. However, in the locked position, as shown in FIG. 6, the second locking mechanism 120 can be positioned directly over the living hinge 112 of the first locking mechanism 110. The second locking mechanism 120 can achieve such a position by being slid towards the distal end of the knife 100 along the Axis A (the term distal, as used herein refers to the end of the knife that is furthest from the user when the handle of the knife is being held). In the locked position, the second locking mechanism 120 can be disposed over the living hinge 112 of the first locking mechanism 110. The second locking mechanism 120 can prevent any movement of the living hinge 112 of the first locking mechanism 110, thus preventing the protrusion 114 from disengaging from the knife opening 190, whether from the use of the blade release button 150 or a large external force.

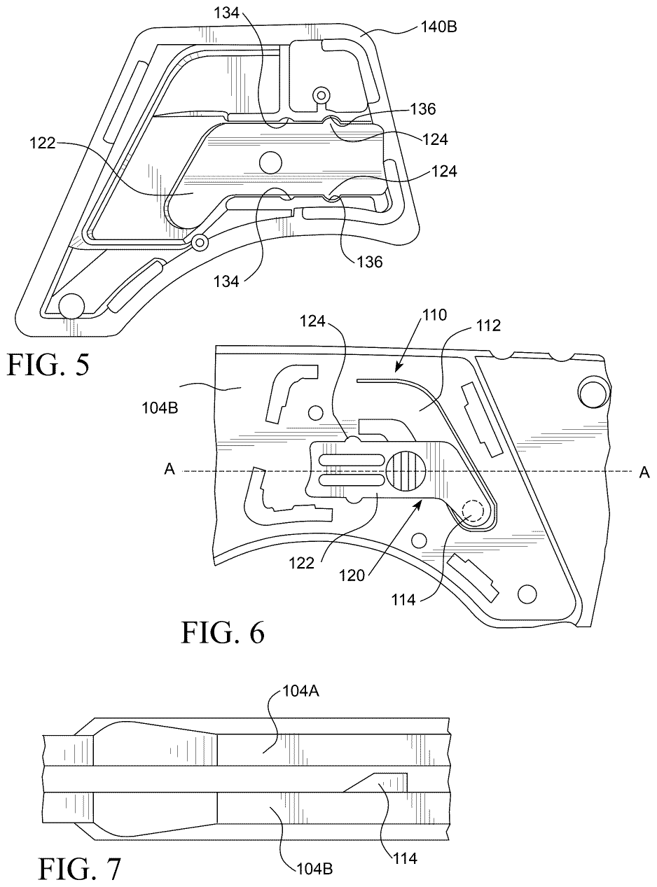

The two positions of the second locking mechanism 120, can be maintained by the use of position holders 134 or 136. These position holders 134, 136 can engage with structures on the second locking mechanism 120. For example, detent(s) 124 can engage with the indents of either position holder 134 or 136 disposed within the second handle cover 140B, as illustrated in FIG. 5. A person with skill in the art will understand that such detents and indents can be swapped with the position holders such that the detents may be on either the second locking mechanism 120 or the second handle cover 140B, and the indents may be on the other of the second locking mechanism or the second handle cover. The second locking mechanism 120 can be positioned by a user via a slide lever 122, which is shown in FIGS. 4 and 6. The user can move the slide lever 122 back and forth to lock and unlock the second locking mechanism 120. Once the user moves the second locking mechanism 120 into the unlocked position, the blade release button 150 is then depressible to enable removal of the replaceable blade 180. Once removed, the user may swap out the blade 180 for one with a different profile, or for a fresh blade that has not been dulled by use.

In some embodiments, the protrusion 114 may include a ramped structure, as shown in FIG. 7, which can ease the engagement of a replaceable blade within the blade carriers 104A and 104B. In FIG. 4, the protrusion 114 is shown on the distal end of the living hinge 112.

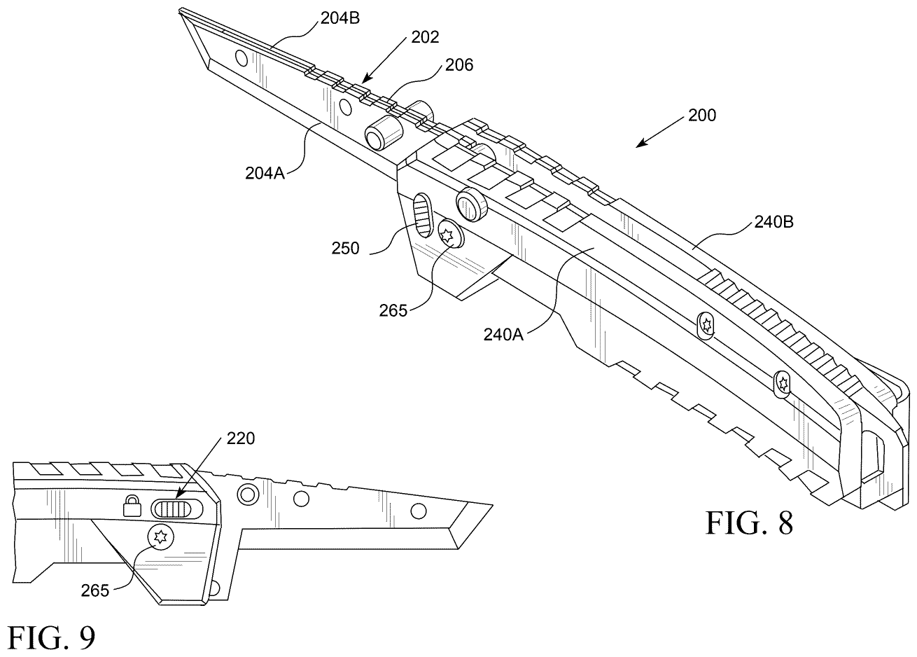

FIGS. 8-15 disclose a second embodiment of an improved locking mechanism for a knife having a replaceable blade. As illustrated in FIG. 8, a knife 200 can have a blade receptacle 202, which can be comprised of a first blade carrier 204A and a second blade carrier 204B; the two blade carriers may be spaced apart via a spacer, or the two blade carriers may be constructed in such a way that does not require a spacer. For example, the first blade carrier 204A may include a thicker construction at its proximal end to act as the spacer, or vice-versa. The spacer 206, or other such spacing methods, can provide an opening in the blade receptacle 202 for the insertion of a replaceable blade, for example, the blade 180 that is shown in FIG. 2. As illustrated, the knife 200 is a folding knife; therefore, the blade carriers 204A-204B can be formed as a separate piece from the tang, which can include the entire blade receptacle 202 portion of knife 200. The tang can be comprised of two blade liners 260, wherein the two blade liners 260 can be disposed on opposite sides of the blade receptacle 202 and include a pivot point 265. The entire blade receptacle 202 can rotate about the pivot point 265 to allow an inserted replaceable blade to nest in between the two blade carriers 204A-204B, which are nested in between the two blade liners 260.

Further, in FIG. 8, knife 200 comprises a first handle cover 240A and a second handle cover 240B. Disposed in between the first handle cover 240A and a blade liner 260 is a blade release button 250. In other versions of knife 200, the blade receptacle 202 may be constructed as a single piece that provides the same opening as with the version constructed with two blade carriers. As with earlier versions of a replaceable blade knife, as described in CN103786170B and its progeny, the blade carriers may include an offset in their profiles to ease insertion of a replaceable blade. As with the older versions, the knife 200 may include a blade release button 250. Such a button may include a coiled spring that maintains the button's position until it is depressed. Once depressed, the blade release button 250 can engage with a living hinge 212, which is part of a first locking mechanism 210. The first locking mechanism 210 can be formed into the proximal end of the blade receptacle 202. Included in the first locking mechanism 210, can be a protrusion 214, which can be structured and configured to engage with an opening on the proximal end of a replaceable blade, for example, opening 190 on the blade 180, as shown in FIG. 2. By inserting a blade 180 into the blade receptacle 202, the protrusion 214 on the living hinge 212 may be displaced until the protrusion 214 fully engages with the opening 190, thereby securing the blade 180 in the blade receptacle 202.

In earlier versions of such replaceable blade knives, the first locking mechanism comprised the locking mechanism used to secure a replaceable blade within the knife. However, due to the nature of the living hinge, some larger external forces can be capable of disengaging the protrusion from the blade opening and allowing the blade to release from the knife without depressing the release button. To ensure that such extreme forces do not overwhelm the first locking mechanism 210, a second locking mechanism 220 can be included in the replaceable blade knife 200.

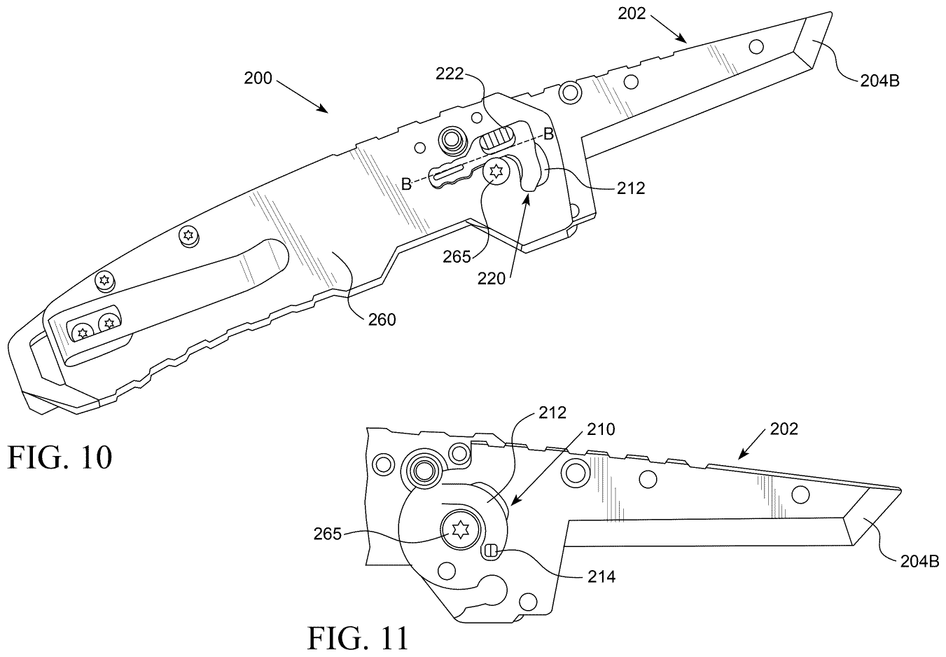

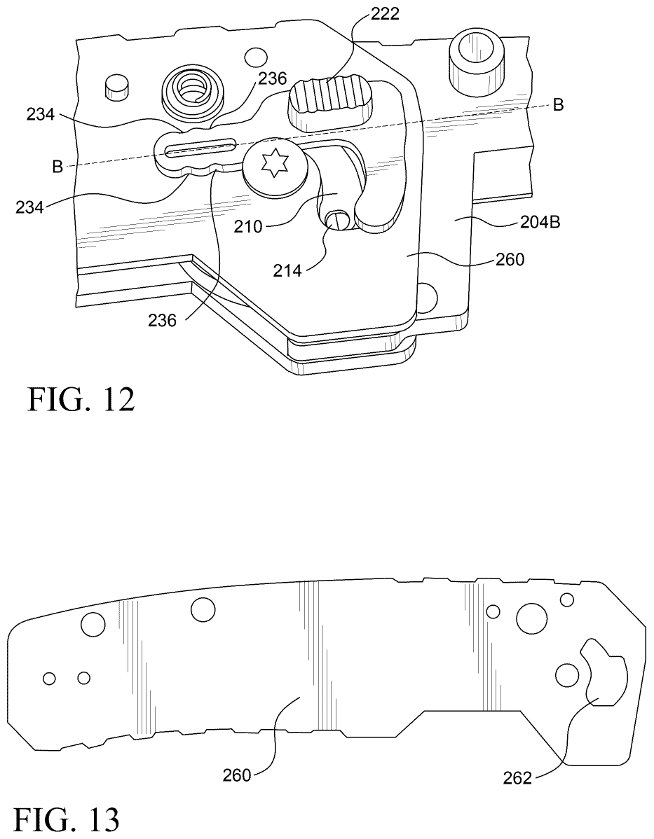

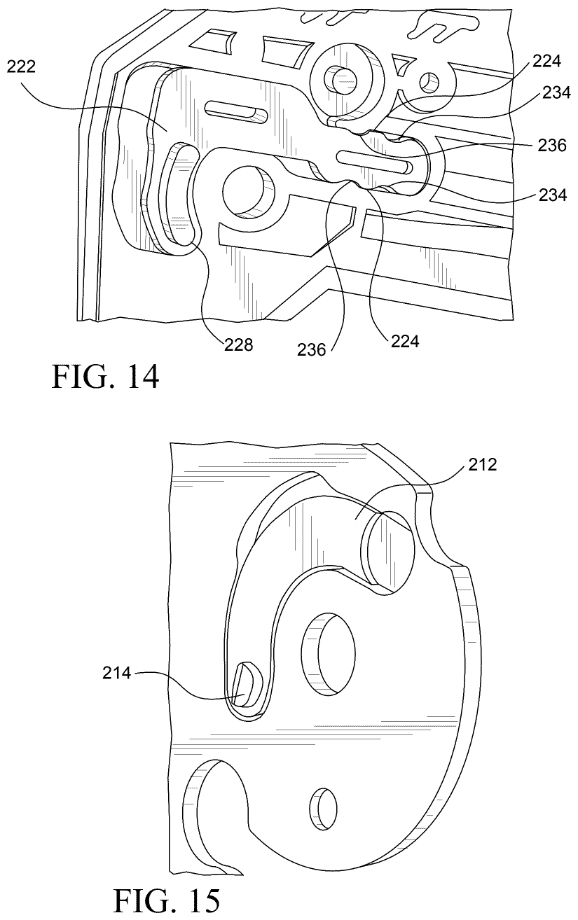

As illustrated in FIGS. 10-16, a second locking mechanism 220 can be disposed over the first locking mechanism 210. In knife 200, the blade liner 260 may be disposed between the first locking mechanism 210 and the second locking mechanism 220. Because there is increased separation between the two locking mechanisms, a footing 228 can be disposed onto the second locking mechanism 220. The footing 228, illustrated in FIG. 14, can mirror the profile of the first locking mechanism 210 and have a width nearly equal to the width of the blade liner 260, as illustrated in FIG. 12. The blade liner 260 may further include a liner opening 262, shown in FIG. 13, which can be configured to let the footing 228 move with the second locking mechanism 220 from a locked to an unlocked position.

The second locking mechanism 220 can be housed within a second cover 240B of the knife 200. Referring to FIGS. 10 and 12, the second locking mechanism 220 can be structured and configured to move along axis B. In FIG. 12, the second locking mechanism 220 is illustrated in an unlocked position. In the unlocked position, the second locking mechanism 220 can be positioned towards the distal end of the blade receptacle 202. In such an arrangement, the second locking mechanism 220 may be adjacent to, but not covering, the living hinge 212 of the first locking mechanism 210. In such an arrangement, the living hinge 210 can be flexed via the release button 250 and, at undesirable times, by a large external force. However, in the locked position, as shown in FIG. 10, the second locking mechanism 220 can be positioned directly over the living hinge 212 of the first locking mechanism 210. The second locking mechanism 220 can achieve such a position by being slid towards the proximal end of knife 200 along the Axis B. In the locked position, the footing 228 of the second locking mechanism 220 can be disposed over the living hinge 212 of the first locking mechanism 210. The second locking mechanism 220 can prevent any movement of the living hinge 212 of the first locking mechanism 210, thus preventing the protrusion 214 from disengaging from the knife opening 190, whether from the use of the blade release button 250 or a large external force.

The two positions of the second locking mechanism 220, can be maintained by the use of position holders 224. The position holder(s) 224 can engage with structures on the second locking mechanism 220. For example, indents 234 or 236 on the slide lever 222 can engage with the detents of position holder 224 disposed on the inner side of the second handle cover 240B, as illustrated in FIG. 14. A person with skill in the art will understand that such detents and indents can be swapped with the position holders such that the indents may be on either the slide lever 222 or the inner side of handle cover 240B, and the detents may be on the other of the slide lever or the inner side of the handle cover. The second locking mechanism 220 can be positioned by a user via the slide lever 222, which is shown in FIGS. 10, 12, and 14. The user can move the slide lever 222 back and forth to lock and unlock the second locking mechanism 220. Once the user moves the second locking mechanism 220 into the unlocked position, they can then depress the blade release button 250 to remove the replaceable blade 180. Once removed, the user may swap out the blade 180 for one with a different profile, or for a fresh blade that has not been dulled by use.

In some embodiments, the protrusion 214 may include a ramped structure, as shown in FIG. 15, which can ease the engagement of a replaceable blade within the blade carriers 204A and 204B. In FIG. 15, a partial cutout of the second locking mechanism 220 is shown where the protrusion 214 is on the distal end of the living hinge 212.

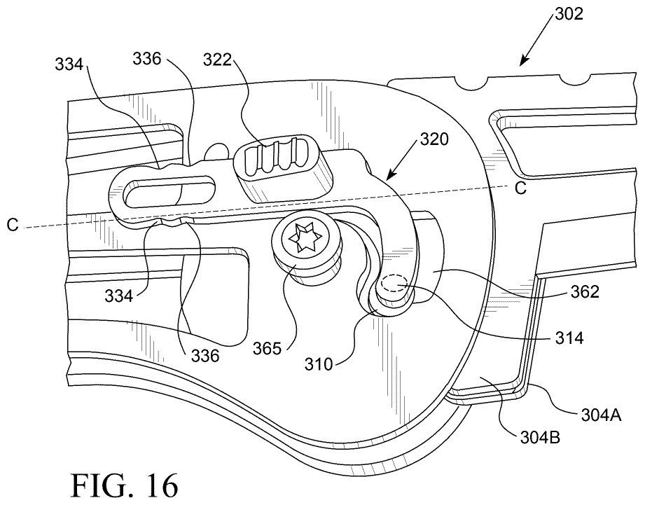

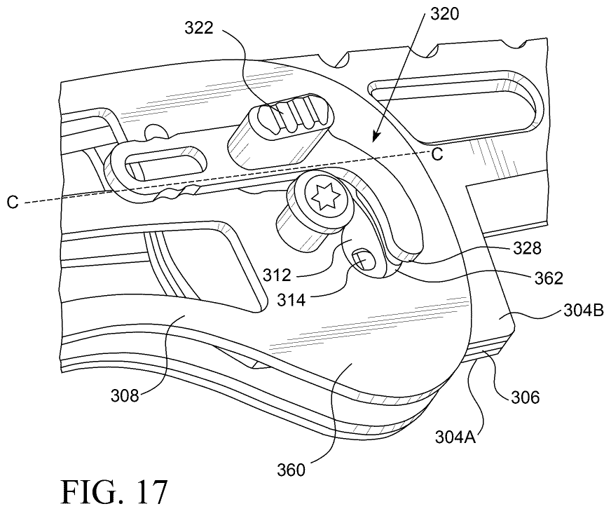

FIGS. 16-19 disclose a third embodiment of an improved locking mechanism for a knife having a replaceable blade. As with the second embodiment, shown in FIG. 8, knife 300 can have a blade receptacle 302, which can be comprised of a first blade carrier 304A and a second blade carrier 304B; the two blade carriers may be spaced apart via a spacer, or the two blade carries may be constructed in such a way that does not require a spacer. For example, the first blade carrier 304A may include a thicker construction at its proximal end to act as the spacer, or vice-versa. As illustrated in FIG. 17, the spacer 306, or other such spacing methods, can provide an opening in the blade receptacle 302 for the insertion of a replaceable blade, for example, the blade 180 that is shown in FIG. 2. As illustrated, the knife 300 is a folding knife; therefore, the blade carriers 304A-304B can be formed as a separate piece from the tang, which can include the entire blade receptacle 302 portion of knife 300. The tang can be comprised of two blade liners 360, wherein the two blade liners 360 can be disposed on opposite sides of the blade receptacle 302, as illustrated in FIGS. 16-17, and include a pivot point 365. The entire blade receptacle 302 can rotate about the pivot point 365 to allow an inserted replaceable blade to nest in between the two blade carriers 304A-304B, which are nested in between the two blade liners 360.

Further in FIG. 19, knife 300 can comprise a first handle cover (not shown) and a second handle cover 340B. As with embodiment two, illustrated in FIG. 8, disposed in between the first handle cover and a blade liner 360 is a blade release button. In other versions of knife 300, the blade receptacle 302 may be constructed as a single piece that provides the same opening as with the version constructed with two blade carriers. As with earlier versions of a replaceable blade knife, as described in CN103786170B and its progeny, the blade carriers may include an offset in their profiles to ease insertion of a replaceable blade. As with the older versions, knife 300 may include a blade release button. Such a button may include a coiled spring that maintains the button's position until it is depressed. Once depressed, the blade release button can engage with a living hinge 312, which is part of a first locking mechanism 310. The first locking mechanism 310 can be formed into the proximal end of the blade receptacle 302. Included in the first locking mechanism 310 can be a protrusion 314, which can be structured and configured to engage with an opening on the proximal end of a replaceable blade, for example, opening 190 on blade 180 as shown in FIG. 2. By inserting a blade 180 into the blade receptacle 302, the protrusion 314 on the living hinge 312 may be displaced until the protrusion 314 fully engages with the opening 190, thereby securing the blade 180 in the blade receptacle 302.

In earlier versions of such replaceable blade knives, the first locking mechanism comprised the locking mechanism used to secure a replaceable blade within the knife. However, due to the nature of the living hinge, some larger external forces can be capable of disengaging the protrusion from the blade opening and allowing the blade to release from the knife without depressing the release button. To ensure that such extreme forces do not overwhelm the first locking mechanism 310, a second locking mechanism 320 can be included in the replaceable blade knife 300.

As illustrated in FIGS. 16-17, a second locking mechanism 320 can be disposed over the first locking mechanism 310. In knife 300, the blade liner 360 may be disposed between the first locking mechanism 310 and the second locking mechanism 320. Because there is increased separation between the two locking mechanisms, a footing 328, shown in FIG. 19, can be disposed over the living hinge 312 of the first locking mechanism 310. The footing 328 can mirror the profile of the first locking mechanism 310 and have a width nearly equal to the width of the blade liner 360. The blade liner 360 may further include a liner opening, similar to liner opening 262, which can be configured to let the footing 328 move with the second locking mechanism 320 from a locked to an unlocked position.

The second locking mechanism 320 can be housed within a second cover 340B of the knife 300. Referring to FIGS. 16 and 17, the second locking mechanism 320 can be structured and configured to move along axis C. In FIG. 17, the second locking mechanism 320 is illustrated in an unlocked position. In the unlocked position, the second locking mechanism 320 can be positioned towards the distal end of the knife 300. In such an arrangement, the second locking mechanism 320 may be adjacent to, but not covering, the living hinge 312 of the first locking mechanism 310. In such an arrangement, the living hinge 310 can be flexed via the release button and, at undesirable times, by a large external force. However, in the locked position, as shown in FIG. 16, the second locking mechanism 320 can be positioned directly over the living hinge 312 of the first locking mechanism 310. The second locking mechanism 320 can achieve such a position by being slid towards the proximal end of the knife 300 along the Axis C. In the locked position, the second locking mechanism 320 can be disposed over the living hinge 312 of the first locking mechanism 310, via the footing 328. The second locking mechanism 320 can prevent any movement of the living hinge 312 of the first locking mechanism 310, thus preventing the protrusion 314 from disengaging from the knife opening 190, whether from the use of the blade release button or a large external force.

The two positions of the second locking mechanism 320, can be maintained by the use of a position holder 324, as illustrated in FIG. 19. The position holder(s) 324 can engage with structures on the slide lever 322 of the second locking mechanism 320. For example, indents 334 or 336 can engage with the detents of position holder 324 disposed on the inner side of handle cover 340B, as illustrated in FIG. 19. A person with skill in the art will understand that such detents and indents can be swapped with the position holders such that the indents may be on either the second locking mechanism 320 or the inner side of cover 340B, and the detents may be on the other of the second locking mechanism or the inner side of the cover. The second locking mechanism 320 can be positioned by a user via a slide lever 322, which is shown in FIGS. 16-17 and 19. The user can move the slide lever 322 back and forth to lock and unlock the second locking mechanism 320. Once the user moves the second locking mechanism 320 into the unlocked position, they can then depress the blade release button to remove the replaceable blade 180. Once removed, the user may swap out the blade 180 for one with a different profile, or for a fresh blade that has not been dulled by use.

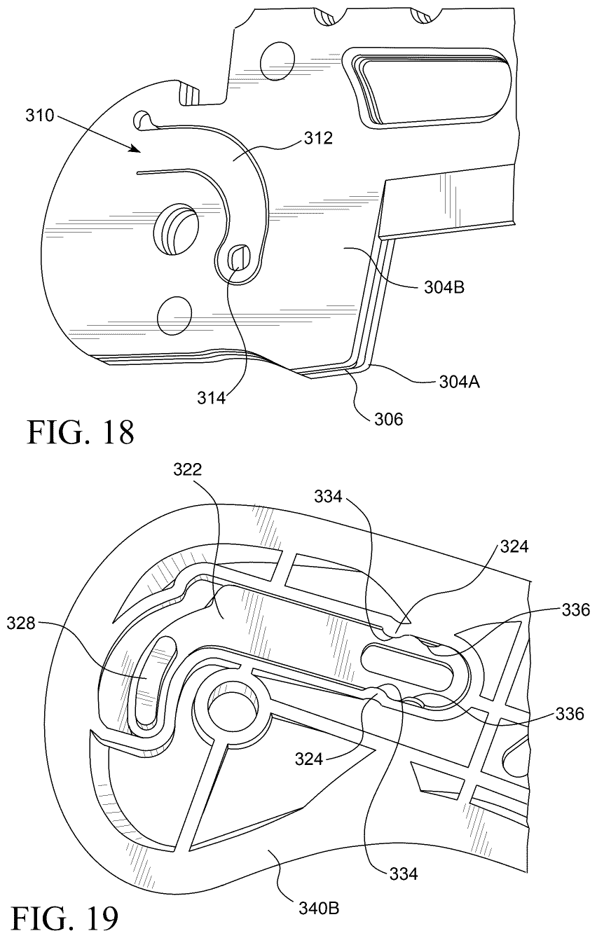

In some embodiments, the protrusion 314 may include a ramped structure, similar to the ramp shown in FIG. 15, which can ease the engagement of a replaceable blade within the blade carriers 304A and 304B. In FIG. 18, the first locking mechanism 310 is shown where the protrusion 314 is on the distal end of the living hinge 312.

Persons of ordinary skill in arts relevant to this disclosure and subject matter hereof will recognize that embodiments may comprise fewer features than illustrated in any individual embodiment described by example or otherwise contemplated herein. Embodiments described herein are not meant to be an exhaustive presentation of ways in which various features may be combined and/or arranged. Accordingly, the embodiments are not mutually exclusive combinations of features; rather, embodiments can comprise a combination of different individual features selected from different individual embodiments, as understood by persons of ordinary skill in the relevant arts. Moreover, elements described with respect to one embodiment can be implemented in other embodiments even when not described in such embodiments unless otherwise noted. Although a dependent claim may refer in the claims to a specific combination with one or more other claims, other embodiments can also include a combination of the dependent claim with the subject matter of each other dependent claim or a combination of one or more features with other dependent or independent claims. Such combinations are proposed herein unless it is stated that a specific combination is not intended. Furthermore, it is also intended to include features of a claim in any other independent claim, even if this claim is not directly made dependent to the independent claim.

What is claimed is:

1. A knife, comprising:
a blade receptacle having a longitudinal axis that is structured and configured to receive a replaceable blade;
a first locking mechanism disposed within the blade receptacle, wherein
the first locking mechanism comprises a biasing element having a first engaging element near a distal end of the biasing element, and
the first engaging element is structured and configured to engage with a corresponding second engaging element on the replaceable blade to retain the replaceable blade within the blade receptacle;
a release mechanism configured to disengage the first engaging element from the second engaging element; and
a second locking mechanism, wherein
the second locking mechanism is positionable between a first position and a second position,
the first position abuts the biasing element to prevent movement of the biasing element, and
the second position is apart from the biasing element and is configured to allow movement of the biasing element.

2. The knife of claim 1, wherein the biasing element is a living hinge.

3. The knife of claim 2, wherein the second locking mechanism is disposed within a plane parallel to the living hinge.

4. The knife of claim 1, wherein the second locking mechanism operates in a plane parallel to the longitudinal axis of the blade receptacle.

5. The knife of claim 1, wherein the first engaging element is one of a protrusion or an opening.

6. The knife of claim 5, wherein the second engaging element is the other of the protrusion or the opening.

7. The knife of claim 6, wherein
the first engaging element is a protrusion,
the second engaging element is an opening, and
the second locking mechanism is a slidable tab that covers the distal end of the biasing element when in the first position.

8. The knife of claim 1, wherein
the second locking mechanism further comprises a cover, a slide lever, a position holder, and at least two position notches,
the position holder and at least two position notches are disposed within a plane parallel to the living hinge,
the position holder is a component of one of the slide lever or the cover,
the at least two position notches are components of the other of the slide lever or the cover,
the at least two position notches comprise a distal position notch and a proximal position notch,
the first position of the second locking mechanism positions the position holder within the distal position notch, and
the second position of the second locking mechanism positions the position holder within the proximal position notch.

9. The knife of claim 8, wherein
the cover is positioned away from the handle,
the at least two position notches are components of a back portion of the cover, and
the position holder is a component of the slide lever.

10. The knife of claim 8, wherein
the cover is positioned over the handle,
the position holder is a component of a back half of the handle cover, and
the at least two position notches are components of the slide lever.

11. The knife of claim 1, wherein the release mechanism is a release button.

12. The knife of claim 1, wherein the second locking mechanism is slidable between the first position and the second position.

13. The knife of claim 1 in combination with the replaceable blade, wherein the first position sandwiches the biasing element between the second locking mechanism and the replaceable blade.

14. The knife of claim 1, wherein
the blade receptacle is comprised of two blade carriers,
the biasing element is an extension of one of the two blade carriers,
the second locking mechanism is positioned on a first side of the biasing element, and
the other of the two blade carriers is positioned on a second side of the biasing element.

15. A method of locking a blade in a knife, the method comprising:
sliding a blade into a blade carrier of a knife until an opening on an end of the blade engages with a protrusion on a first locking mechanism, wherein the first locking mechanism comprises the protrusion on an end of a biasing element; and
pushing a slide lever along a longitudinal axis until at least a portion of the slide lever covers the protrusion of the first locking mechanism.
